(19) United States
(12) Patent Application Publication
(10) Pub. No.: US 2015/0170166 A1
(43) Pub. Date: Jun. 18, 2015

(54) SYSTEMS, METHODS, AND COMPUTER PROGRAM PRODUCTS FOR MANAGING TRANSACTION DATA

(71) Applicant: JVL VENTURES, LLC, New York, NY (US)

(72) Inventors: Joseph B. Pearson, Cedar Park, TX (US); Anthony J. Sabetti, Murphy, TX (US); Todd A. Strickler, Rockville, MD (US)

(21) Appl. No.: 14/571,893

(22) Filed: Dec. 16, 2014

Related U.S. Application Data
(60) Provisional application No. 61/917,113, filed on Dec. 17, 2013.

(51) Int. Cl. G06Q 30/02; G06Q 20/34; G06Q 20/32

(52) U.S. Cl. CPC G06Q 30/0201; G06Q 20/3278; G06Q 20/352

(57) ABSTRACT

Systems, methods, and computer-program products are provided for managing transaction data. First record data is received, over a communications network, from a first reader terminal associated with a first merchant system. Second record data is received, over a communications network, from a second reader terminal associated with a second merchant system. The first record data and second record data are related with a profile corresponding to an application identifier (ID). The first record data is associated with a first transaction between the first reader terminal and a transaction instrument, and the second record data is associated with a second contactless transaction between the second reader terminal and the transaction instrument. The transaction instrument includes an application associated with the application ID. The first merchant system and the second merchant system are unassociated and not operable to share record data between each other.

### CROSS REFERENCE TO RELATED APPLICATION

This application claims priority to U.S. Provisional Patent Application No. 61/917,113, filed Dec. 17, 2013, the entire contents of which are incorporated herein by reference.

### BACKGROUND

1. Field

The current invention generally relates to processing data from transactions. More specifically, the current invention relates to systems, methods, and computer program products for managing transaction data, in particular contactless transaction data.

2. Related Art

Customer relationship management (CRM) service providers assist entities (e.g., businesses, merchants, or organizations) in managing their relationship and marketing efforts with their patrons (e.g., customers or members). These CRM service providers can assist an entity by providing various tools and data, such as the creation and management of profiles for individual customers. Using those tools and data the entities can better understand their patrons and tailor their products and services to particular patrons. For example, a business may be able to send a targeted advertisement or offer individually to a customer based upon the customer profile developed by the CRM service provider.

In a commerce environment, for example customer profiles have generally been developed using data from past purchases within a particular business. For example, the business may have a loyalty program. In such a program, a customer registers for a loyalty card or number and uses the card when completing a purchase of goods or services. From the loyalty card, CRM service providers can build a profile based upon the purchases associated with that card.

To date, CRM profiles have been limited because the purchases and information used to develop a profile are from a single system or set of associated systems (e.g., a retailer's system or systems) relating to a particular business. Therefore, a system, method, and program are needed to manage transaction data among systems that are unassociated and/or not operable to share record data, such as purchase history, between each other.

### BRIEF DESCRIPTION

The example embodiments presented herein meet the above-identified needs by providing systems, methods, and computer program products for managing transaction data.

In one example embodiment, the invention relates to a system for managing transaction data. The system includes at least one memory and at least one processor coupled to the at least one memory. The at least one memory is operable to store a plurality of record data. The at least one processor is operable to receive, over a communications network, first record data from a first reader terminal associated with a first merchant system; receive, over a communications network, second record data from a second reader terminal associated with a second merchant system; and relate the first record data and second record data with a profile corresponding to an application identifier (ID). The first record data is associated with a first transaction between the first reader terminal and a transaction instrument, and the second record data is associated with a second contactless transaction between the second reader terminal and the transaction instrument. The transaction instrument includes an application associated with the application ID. The first merchant system and the second merchant system are unassociated and not operable to share record data between each other.

In another example embodiment, the invention relates to a method for managing transaction data. The method includes the steps of receiving, over a communications network, first record data from a first reader terminal associated with a first merchant system; receiving, over a communications network, second record data from a second reader terminal associated with a second merchant system; and relating the first record data and second record data with a profile corresponding to an application identifier (ID). The first record data is associated with a first transaction between the first reader terminal and a transaction instrument, and the second record data is associated with a second contactless transaction between the second reader terminal and the transaction instrument. The transaction instrument includes an application associated with the application ID. The first merchant system and the second merchant system are unassociated and not operable to share record data between each other.

In yet another example embodiment, the invention relates to a non-transitory computer-readable medium having stored thereon sequences of instruction. The sequences of instruction are for causing at least one processor to receive, over a communications network, first record data from a first reader terminal associated with a first merchant system; receive, over a communications network, second record data from a second reader terminal associated with a second merchant system; and relate the first record data and second record data with a profile corresponding to an application identifier (ID). The first record data is associated with a first transaction between the first reader terminal and a transaction instrument, and the second record data is associated with a second contactless transaction between the second reader terminal and the transaction instrument. The transaction instrument includes an application associated with the application ID. The first merchant system and the second merchant system are unassociated and not operable to share record data between each other.

### BRIEF DESCRIPTION OF THE DRAWINGS

The features and advantages of the example embodiments presented herein will become more apparent from the detailed description set forth below when taken in conjunction with the following drawings.

FIG. 1 is a diagram of a system for managing transaction data, according to an exemplary embodiment.

FIG. 2 is a diagram of a system for managing transaction data, according to an exemplary embodiment.

FIG. 3 is a diagram of a system for managing transaction data, according to another exemplary embodiment.

FIGS. 4A, 4B, and 4C are sequence diagrams for managing transaction data, according to an exemplary embodiment.

FIG. 5 is a sequence diagram for managing transaction data, according to an exemplary embodiment.

FIG. 6 is a collaboration diagram of functional modules deployed on a computer system, according to an exemplary embodiment.

### DETAILED DESCRIPTION

I. Overview

The example embodiments presented herein are directed to systems, methods, and computer program products for managing transaction data. This description is not intended to limit the application of the example embodiments presented herein. Also, the example embodiments presented herein are for managing contactless transaction data. But, after reading the following description, it will be apparent to one skilled in the relevant art(s) how to implement the following example embodiments in alternative embodiments that can be utilized, for example, with other types of transactions including those involving, for example, chip and pin (“smart card”) technology.

A customer may use a transaction instrument (e.g., mobile device) to perform various transactions, each with unassociated merchant systems. An application that has an associated application identifier (ID) is stored on the transaction instrument and used during the transaction. Such an application may be, for example, a mobile wallet that has been stored in and utilized by a mobile device to conduct contactless transactions, and the application ID may be a wallet ID. A system, method and computer program product, as discussed in detail below, can be used to receive the application ID together with record data from each of the various transactions with unassociated merchant systems. The record data for each transaction may, in turn, be related and stored with a profile associated with the application ID.

The terms “application,” “applet,” “widget” and/or the plural form of these terms are used interchangeably herein to refer to an application (functioning independently or in conjunction with other applications) or set or subset of instructions or code, which when executed by one or more processors (e.g., in a mobile device or server) causes the processor(s) to perform specific tasks.
II. System for Managing Transaction Data

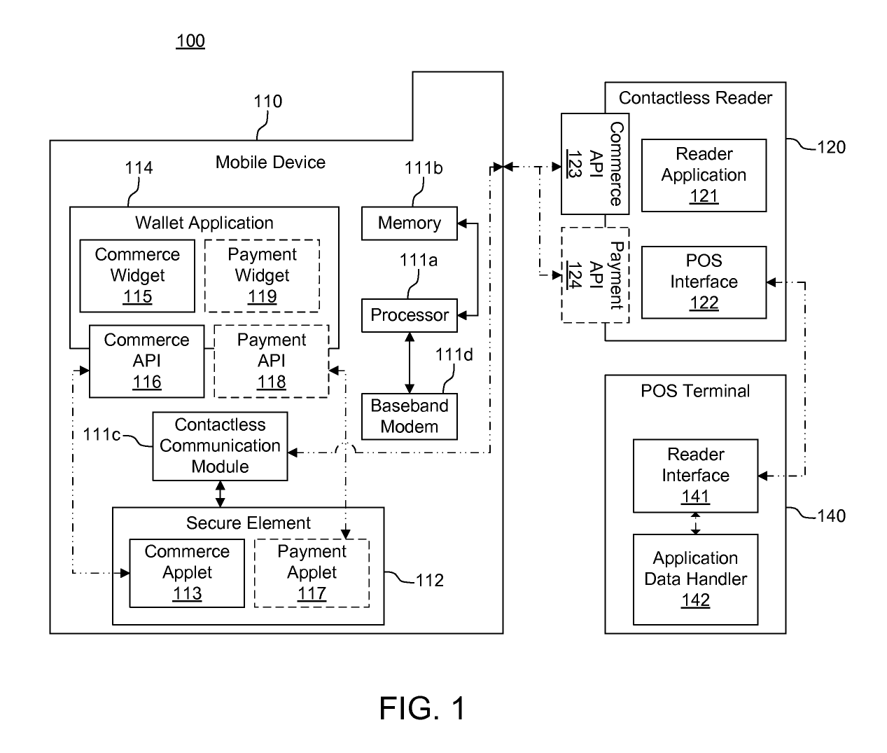

FIG. 1 is a diagram of a system 100 for managing transaction data, according to an exemplary embodiment. Any suitable transaction instrument may be used by a customer to perform a transaction with a reader including, for example, a transaction instrument equipped with a communications module for conducting contactless transactions. Contactless transactions will first be described with reference to FIG. 1.

To conduct a contactless transaction, a tap is performed by placing the transaction instrument within a predetermined proximity to a reader 120. In this embodiment, the transaction instrument is mobile device 110, although it may be another suitable instrument such as, a chip card having a near field communications module. When tapped, the mobile device 110 becomes communicatively coupled to the reader 120 and exchanges data with the reader 120 while within the predetermined proximity to the reader 120. The reader 120 also is communicatively coupled to a point of sale (POS) terminal 140, where goods and/or services can be purchased. The point of sale terminal 140 may be within the same housing as reader 120. Alternatively, point of sale terminal 140 and reader 120 are communicatively coupled with each other but each of these components is housed separately. Reader 120 includes a reader commerce application 121 (referred to herein simply as a “reader application”) and a POS interface 122. Reader 120 manages two interfaces: one interface is with the secure element 112 in the mobile device 110 and the other interface is with POS terminal 140 which includes a reader interface 141 and an application data handler 142. The functionality of reader 120 is the same whether reader 120 is standalone and connected to a payments terminal or merchant POS, or is integrated therein. The reader 120 also includes a reader payment application (not shown) as part of the reader application 121. Contactless transactions are described in further detail in U.S. Patent Appln. Pub. No. 2013/0317924, the entire contents of which are incorporated herein by reference.

In one example embodiment, the mobile device 110 is a cellular phone. In other embodiments, the mobile device 110 may be a tablet, a computer, or another type of device with connectivity to one or more mobile networks. Mobile device 110 includes a processor 111a, memory 111b, a contactless communication module 111c, a baseband modem 111d, and a user interface such as a display (not shown). Baseband modem 111d is a digital modem that is used for mobile network communications. The contactless communication module 111c is circuitry that enables the mobile device 110 to exchange data with the reader 120. In one example embodiment, the contactless communication module 111c is used to exchange data between a secure element (SE) 112 of the mobile device 110. The contactless communication module 111c may be designed to work with, for example, near filed communications (NFC) using ISO 14443 protocol or Bluetooth® technology. Secure element 112 may be implemented as a Universal Integrated Circuit Card (UICC), embedded SE card, secure micro secure digital (microSD) card, and the like. Secure element 112 may also be implemented as a virtual secure element, which can be maintained outside of the mobile device 110 on a memory accessible by the mobile device 110, including but not limited to, for example, a remote server or computer, in the cloud, and the like. Secure element 112 is generally considered secure because it is a self-contained system, including dedicated memory, and is protected by hardware and software hardening techniques that are verified by independent testing.

Secure element 112 may include (e.g., stored thereon) one or more commerce applets. In one example embodiment, secure element 112 includes a commerce applet 113 associated with one or more commerce services and accounts issued by commerce service providers (SPs). A service provider is a company, organization, entity, or the like, that provides services to customers or customers. Examples of service providers include merchants or companies issuing offers and/or loyalty accounts. A service may be an activity, capability, functionality, work, or use that is permitted or provided by a service provider, such as an offer or loyalty service.

Generally, a commerce applet 113 stores both loyalty and offer related data, providing one or more interfaces through which this data can be managed and used. Commerce applet 113 operates as a generic storage container, allowing multiple loyalty/offers services to share mechanisms (e.g., secure element, mobile device) for loyalty/offer data management. If memory restrictions and performance requirements limit the amount of loyalty/offers data that can be stored on secure element 113, additional data can be stored in mobile device memory 111b and managed by the customer via commerce widget 115. For example, any graphic images related to an offer can be stored in memory 111b in order to optimize secure element memory allocation.

Commerce applet 113 includes a cached merchant data table enabling the storage/management of all data related to a given merchant. This allows the commerce data for a given merchant to be pre-loaded in secure element 112 or mobile device 110 by a wallet application 114. A commerce applet 113 interfaces with reader 120 via a commerce application programming interface (API) 123. In an exemplary embodiment, a commerce applet 113 is in the form of a JavaCard applet and is accessible and manageable through the use of application protocol data unit (APDU) commands as defined in ISO 7816-4.

Secure element 112 can also include one or more payment applets 117. Each payment applet 117 is associated with a payment service and an account issued by a payment service provider. One or more payment applets 117 also can be loaded onto the secure element 112, for example, during manufacture and/or configuration of the secure element 112 and may be personalized to enable its use to conduct payment transactions. A payment applet 117 interfaces with reader 120 via API 124. In an exemplary embodiment, payment applet 117 is in the form of a JavaCard applet and is accessible through the use of APDU commands as defined in ISO 7816-4.

It should be understood that other communications between the aforementioned devices may include communications with or through other intervening systems, hardware, and/or software, and such communications may include receiving, transferring, and/or managing data.

A wallet application 114 stored on mobile device 110 includes instructions which, when executed by the processor of the mobile device 110, cause the mobile device 110 to act as an instrument, for example, for processing transactions such as contactless commerce and/or payment transactions. The wallet application 114 serves as the primary user interface and allows a customer to access or use one or more services provided by service providers, communicate with service providers, and/or interact with contactless services and/or control the operation of contactless hardware of the mobile device 110. The wallet application 114 is also used to manage the contactless transaction and contactless transaction data. In one exemplary embodiment, the wallet application 114 is associated with a unique wallet identification (ID). The wallet ID generally corresponds to a particular customer. Wallet application 114 communicates, through the use of APDU commands as defined in ISO 7816-4, with the commerce applet 113 via commerce API 116 and to payment applet 117 via payment API 118.

Commerce widget 115 is a component of the wallet application 114 that provides an interface for customers to manage commerce elements (e.g., loyalty card credentials, offers and rewards), for example, through interactions with the display or user interface of a mobile device. Commerce widget 115 maintains, for example, a master list of commerce elements present on the handset in the secure element 112 or a memory of the mobile device (e.g., 111b). A subset of offers that have been identified as ready to be used are, in turn, moved to secure element 112 to be communicated to contactless reader 120 and POS terminal 140. Sensitive information, such as loyalty account identifiers can be stored on secure element 112.

Payment widget 119 is a component of the wallet application 114 that provides an interface for customers to manage payment elements (e.g., credit or debit card credentials), for example, through interactions with the display or user interface of a mobile device.

The mobile device 110 and the reader exchange a series of commands and data to complete a contactless transaction. This exchange is described in, for example U.S. Patent Appln. Pub. No. 2013/0317927, the entire contents of which are incorporated herein by reference. Regardless of which payment applet 117 or commerce applet 113 is used, the wallet ID is transmitted by the wallet application 114 to the reader 120. In this embodiment, the wallet ID is then passed to the point of sale terminal 140 and received by the application data handler 142. The application data handler 142 then correlates the wallet ID with the goods and or services that were transacted for as record data for that contactless transaction.

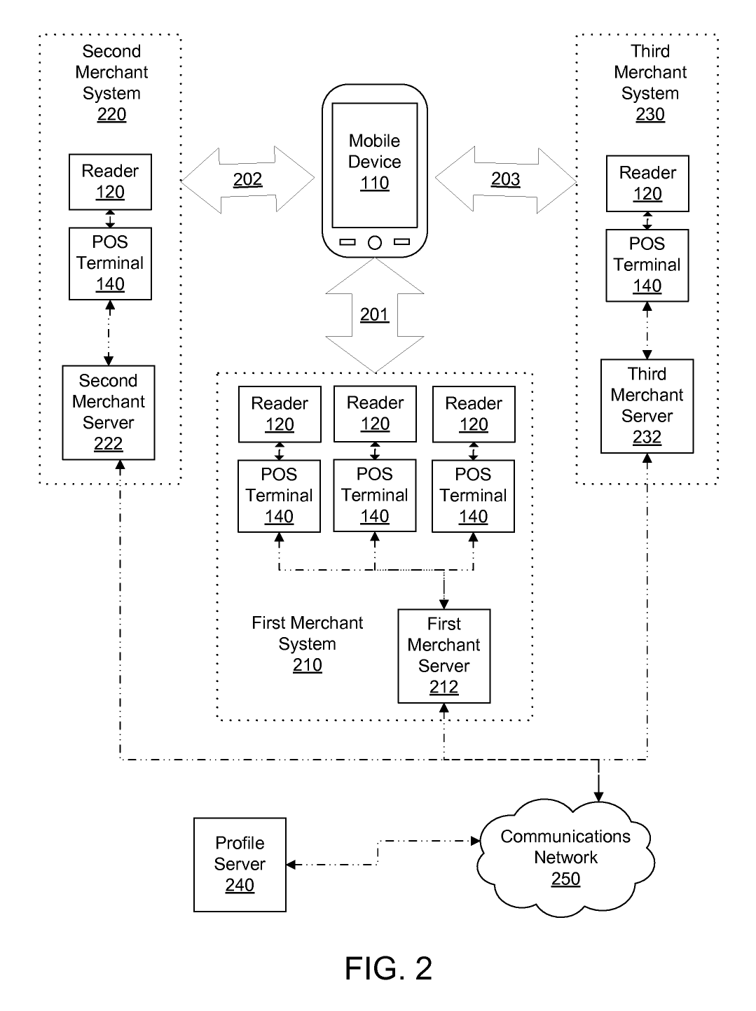

As shown in FIG. 2, mobile device 110 may be used by a customer to conduct several transactions, for example, a first transaction 201 with a first merchant system 210, a second transaction 202 with a second merchant system 220, and a third transaction 203 with a third merchant system 230. Each of the first, second, and third merchant systems 210, 220, 230 include at least one reader 120 and at least one POS terminal 140 communicatively coupled to a first merchant server 212, a second merchant server 222, and a third merchant server 232, respectively. Each merchant system 210, 220, 230 may include several readers 120, and POS terminals 140. The first merchant system 210 is shown in FIG. 2 with three readers 120 coupled to three POS terminals 140. Each of the first, second, and third merchant servers 212, 222, 232, is not limited to a single server and may be implemented on more than one server.

As shown in FIG. 2, the first, second, and third merchant systems 210, 220, 230 are unassociated and not operable to share data between or with each other. For example, none of the first, second, and third merchant servers 212, 222, 232 are communicatively coupled to one another. The first, second, and third merchant servers 212, 222, 232 are communicatively coupled to a profile server 240 over a communications network 250. The profile server 240 may be implemented on one or more servers. As will be discussed further below, the profile server 240 is configured to receive the record data from each of the first, second, and third merchant servers 212, 222, 232 and relate the record data with a profile corresponding to the wallet ID corresponding to the mobile device 110. In this example embodiment, the profile server 240 is operated by a CRM service provider.

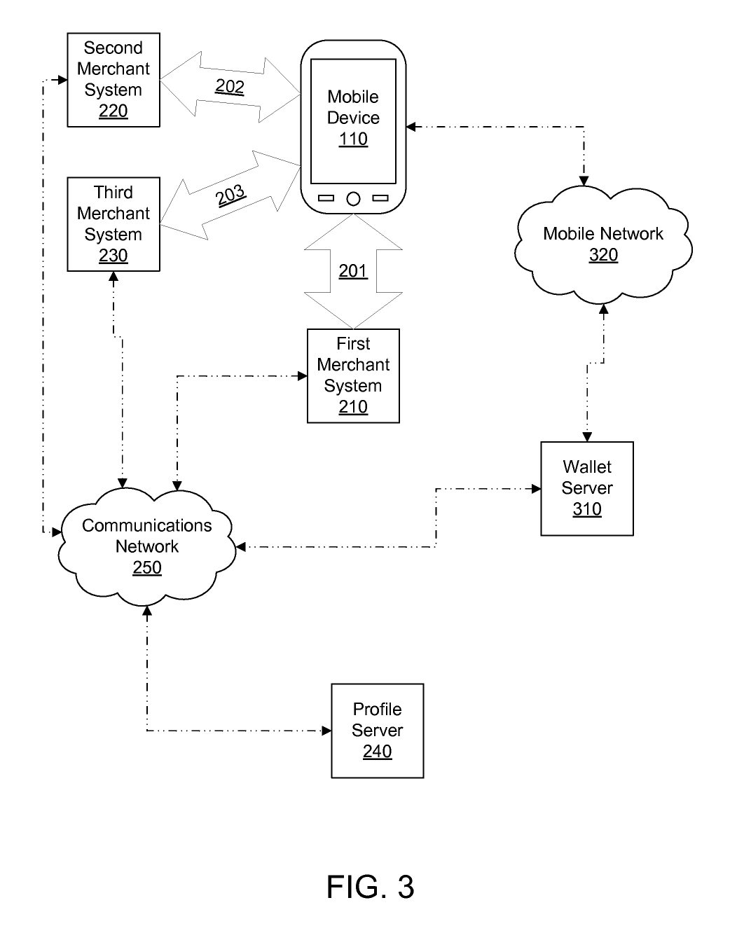

In another example embodiment shown in FIG. 3, the mobile device 110 is communicatively coupled to a wallet server 310 through a mobile network 320. The wallet server 310, among other things, manages communications with the wallet application 114, tracks the state of the wallet application 114 (e.g., by storing states of the wallet application 114 in a wallet database), and provides interfaces for communication with other computer systems. Further details of wallet server 310 and communication with the wallet application 114 may be found in, for example, U.S. Patent Appln. Pub. No. 2014/0012750, the entire contents of which are hereby incorporated by reference herein. The mobile network 320 may be mobile phone cellular networks, radio networks, and/or other types of networks, each of which may be operated by a corresponding mobile network operator. The wallet server 310 is also communicatively coupled to the profile server 240 through the communications network 250. The profile server 240 is thus enabled to receive data from the wallet server 310, as discussed further below.
III. Process for Managing Transaction Data

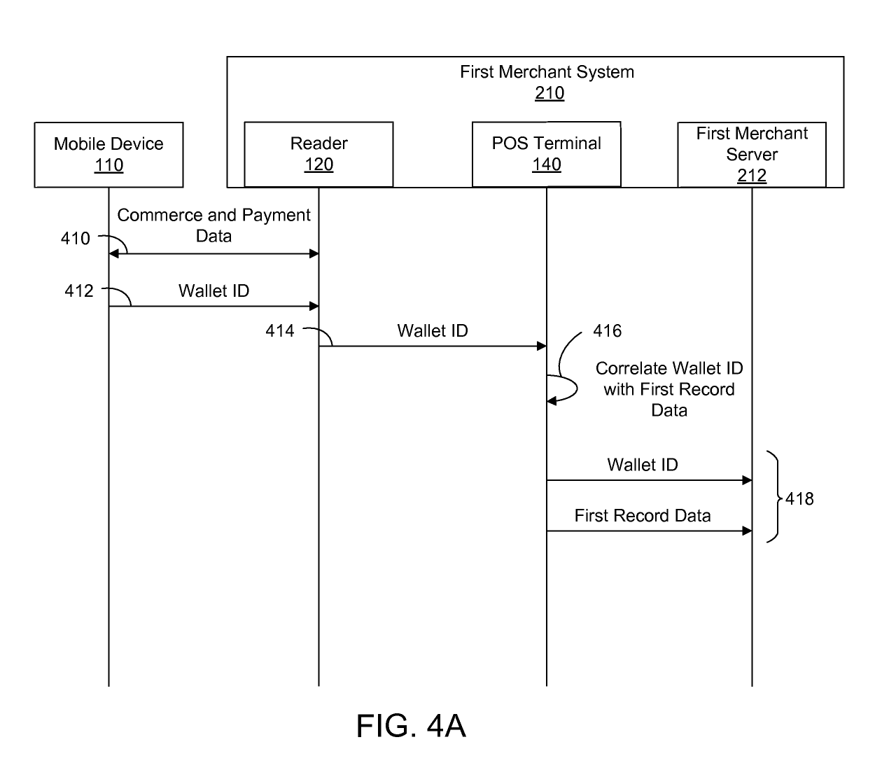

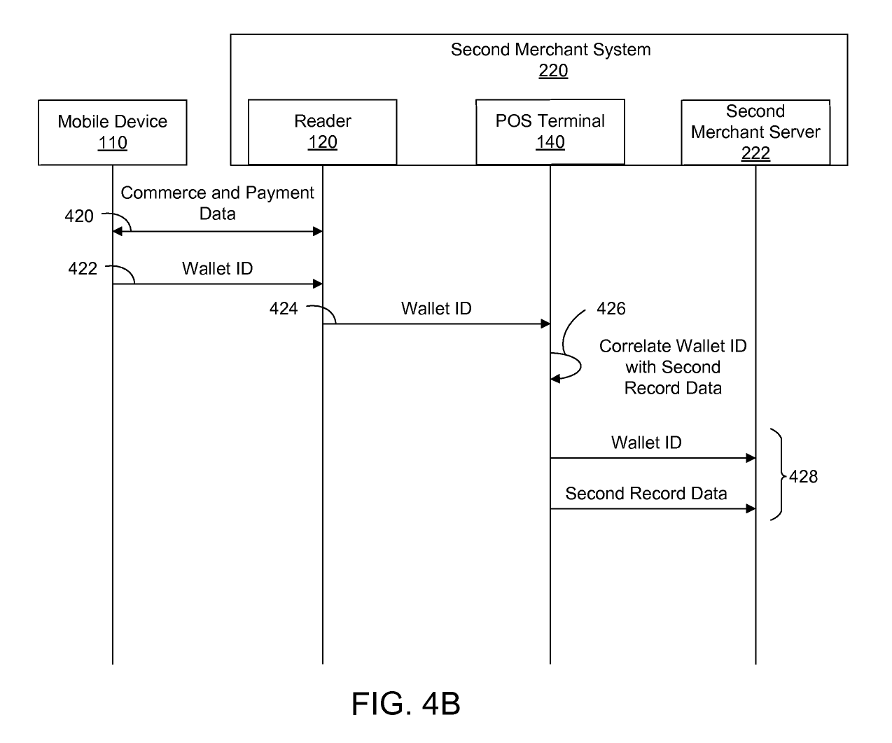

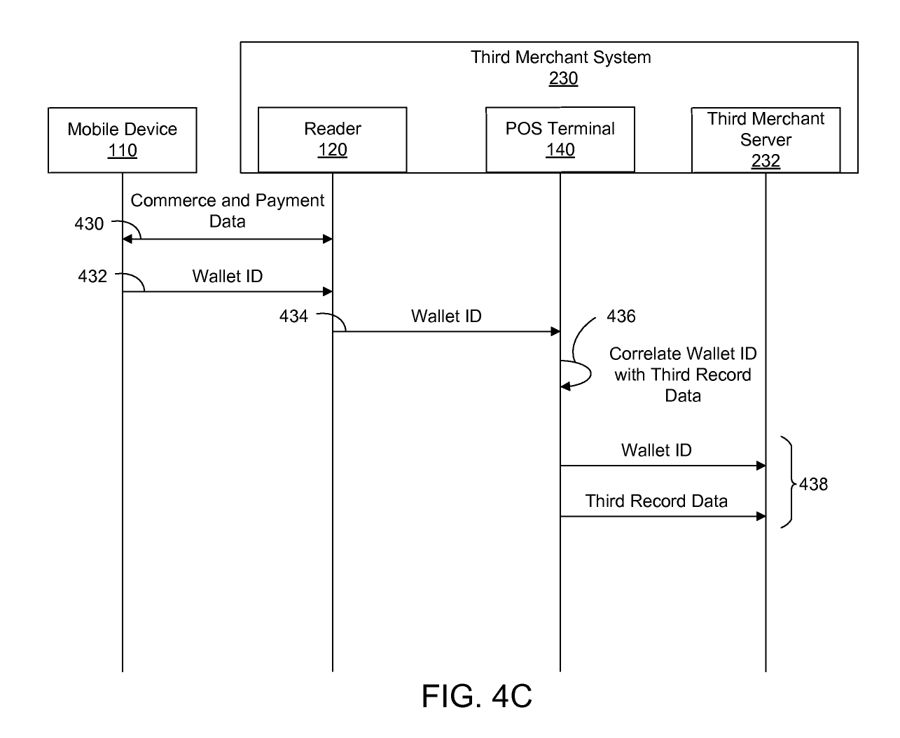

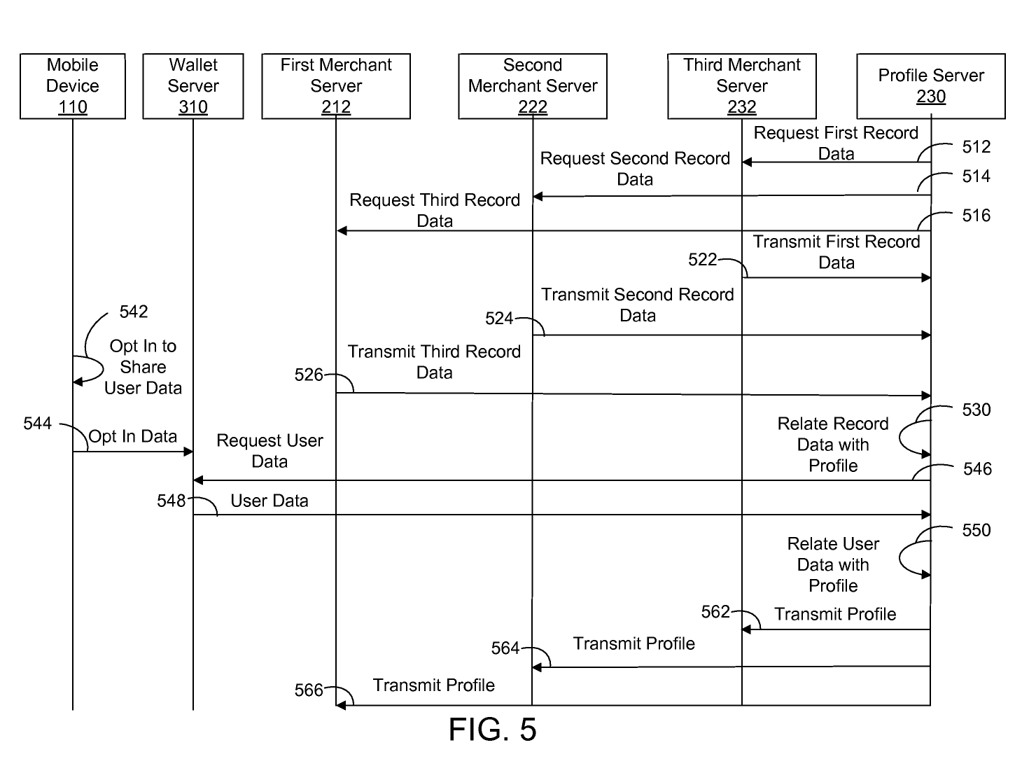

FIGS. 4A, 4B, 4C, and 5 are sequence diagrams for managing transaction data, according to an exemplary embodiment. FIG. 4A is a sequence diagram for processing a first transaction (e.g., 201 in FIGS. 2 and 3) between the mobile device 110 and the first merchant system 210. The mobile device 110 is placed in proximity to a reader 120 of the first merchant system 210, and a wireless connection is established between the mobile device 110 and the reader 120 of the first merchant system 210. The reader 120 and the mobile device 110 exchange data to complete the commerce and/or payment transaction (e.g., tap event) in step 410. This data exchange is described in, for example, U.S. Patent Appln. No. 2013/031724, the entire contents of which are incorporated herein by reference. As part of the contactless transaction, the wallet application 114 of the mobile device 110 transmits the wallet ID corresponding to the wallet application 114 in mobile device 110 to the reader 120 in step 412.

The wallet ID is transmitted from the reader 120 to the POS terminal 140 in step 414. In step 416 the application data handler 142 of the POS terminal 140 correlates the wallet ID with the goods or services that were transacted for in the first transaction 201. Information regarding the goods and services that were transacted for in the first transaction 201 are part of the first record data associated with the first transaction 201. Information regarding the goods and services includes, for example, a name of a product or service purchased, stock keeping units (SKUs), price, and the like. If the commerce applet 113 was used to provide an offer as part of the first transaction, the offer data may also be part of the first record data. The record data is not limited to these examples, however, and pertinent data may be included in the record data, such as a merchant identifier, a geographical location of the merchant, and the POS terminal used in the transaction, along with other information related to the transaction. In step 418, the first record data together with the wallet ID are transmitted from the POS terminal 140 to the first merchant server 212.

FIG. 4B is a sequence diagram for processing a second transaction (e.g., 202 in FIGS. 2 and 3,) between the mobile device 110 and the second merchant system 220 and is similar to the sequence diagram shown in FIG. 4A. In particular, the mobile device 110 is placed in proximity to a reader 120 of the second merchant system 220, and a wireless connection is established between the mobile device 110 and the reader 120 of the second merchant system 220. The reader 120 and the mobile device 110 exchange data to complete the commerce and/or payment transaction (e.g., tap event) in step 420, and the wallet application 114 of the mobile device 110 transmits the wallet ID corresponding to the wallet application 114 in mobile device 110 to the reader 120 in step 422. The wallet ID is transmitted from the reader 120 to the POS terminal 140 in step 424. In step 426, the application data handler 142 correlates the wallet ID with the second record data for the second transaction 202. In step 428, the second record data together with the wallet ID are transmitted from the POS terminal 140 to the second merchant server 222.

Likewise, FIG. 4C is a sequence diagram for processing a third transaction (e.g., 203 in FIGS. 2 and 3) between the mobile device 110 and the third merchant system 230. In particular, the mobile device 110 is placed in proximity to a reader 120 of the third merchant system 230, and a wireless connection is established between the mobile device 110 and the reader 120 of the third merchant system 230. The reader 120 and the mobile device 110 exchange data to complete the commerce and/or payment transaction (e.g., tap event) in step 430, and the wallet application 114 of the mobile device 110 transmits the wallet ID corresponding to the wallet application 114 in mobile device 110 to the reader 120 in step 432. The wallet ID is transmitted from the reader 120 to the POS terminal 140 in step 434. In step 436, the application data handler 142 correlates the wallet ID with the third record data for the third transaction 203. In step 438, the third record data together with the wallet ID are transmitted from the POS terminal 140 to the third merchant server 232.

As discussed above, record data include various data from the transaction including the goods and services that have been transacted for during the respective transaction. The record data is preferably data that is useful to a CRM service provider to develop a profile of the customer.

FIG. 5 shows a sequence diagram for developing or augmenting a profile of a customer. A CRM service provider requests record data associated with a particular wallet ID. That is, the profile server 240 requests from the first, second, and third merchant servers 212, 222, 232 the first, second, and third record data, respectively, in steps 512, 514, and 516. In response, the first, second, and third merchant servers 212, 222, 232 transmit the first, second, and third record data to the profile server 240 in steps 522, 524, and 526, respectively. In an alternate example embodiment, the first, second, and third merchant servers 212, 222, 232 transmit the first, second, and third record data to the profile server 240 without a request from the profile server. In such a case, the wallet ID is transmitted with the respective record data.

Once the profile server 240 receives the first, second and third record data, each of the record data is then related to a profile corresponding to the wallet ID in step 530. The record data may be related to the profile, for example, by being associatively stored in a database containing the purchases associated with the particular wallet ID. The purchases, for example, may be analyzed to develop a profile for the particular customer associated with the wallet ID.

To date, such profiles have been limited to a single merchant. While robust profiles could be developed, for example, at so called “big box stores” (e.g., Target®, Wal-Mart®, and the like), they are particularly limited for more specialized stores. With a big box store, for example, the purchases could be analyzed for a customer using a loyalty program. A profile could then be developed that indicates a customer purchasing infant clothing, diapers, and toys is expecting or has a newborn child. In such a way, offers and advertisements for goods or services relevant to an expectant or new parent could be provided to the customer. This approach has not been effective, however, where the purchases are made at merchants whose systems are not associated with each other. And, thus the aforementioned system and method has been developed to enhance the effectiveness of such a profile. For example, where the first merchant corresponds to a children's furniture store, the second merchant corresponds to a children's clothing store, and the third merchant corresponds to a toy store, the purchases made at these three merchants with the same transaction instrument having the wallet ID can be analyzed together in the system described herein, to develop a profile that identifies the customer associated with the wallet ID as a new or expecting parent. In such a way, these three merchants, or even other additional merchants such as a day care service provider, can provide relevant offers and advertisements for a new or expectant parent to the customer associated with the wallet ID.

In another example embodiment, the profile may be developed by using user data. As shown in FIG. 5, a user may opt in to provide user data in step 542. Such user data may include, for example, information about the user's age, gender, marital status, children, and the like. The user may select an option on the wallet application 114 to provide this user information as part of the customer profile. In another example, a user may allow his/her social media accounts, e.g., Facebook® or Twitter®, to be linked to the wallet application 114, where information about the user from these accounts may be part of the user data. After the user opts in using the wallet application 114 in step 542, the mobile device 110 sends data to the wallet server 310 using the mobile network 320 in step 544 to indicate that the user has opted in to sharing user data. In step 546, the profile server then request for user data from the wallet server 310. The wallet sever 310 responds by sending the user data to the profile server 240 in step 548. Once the profile server 240 receives the user data, the user data is then related to a profile corresponding to the wallet ID in step 550. As with the record data, the user data may be alternatively transmitted to the profile server 240 from the wallet server 310 without a request from the profile sever 240, and, in this case, the user data is transmitted with the wallet ID.

As discussed above, once the profile has been developed or augmented, the profile may then be used to develop relevant offers, advertisements, and the like. To do so, in one example embodiment, the profile server transmits the profile to the first, second, and third merchant servers in steps 562, 564, and 566. The respective merchants may then use the merchant servers 212, 222, 232 to develop relevant offers, advertisements and the like. In other example embodiments, the profile server 240 may transmit the profile to the wallet server 310 or other servers operated by a forth merchant or third parties. In yet another example embodiment, the CRM service providers themselves may develop the offers, advertisements and the like using the profile server or another communicatively coupled sever.
IV. Computer Readable Medium Implementation

The example embodiments described above, such as, for example, the systems and procedures depicted in or discussed in connection with FIGS. 1 through 5 or any part or function thereof, may be implemented by using hardware, software or a combination of the two. The implementation may be in one or more computers or other processing systems. While manipulations performed by these example embodiments may have been referred to in terms commonly associated with mental operations performed by a human operator, no human operator is needed to perform any of the operations described herein. In other words, the operations may be completely implemented with machine operations. Useful machines for performing the operation of the example embodiments presented herein include general-purpose digital computers or similar devices.

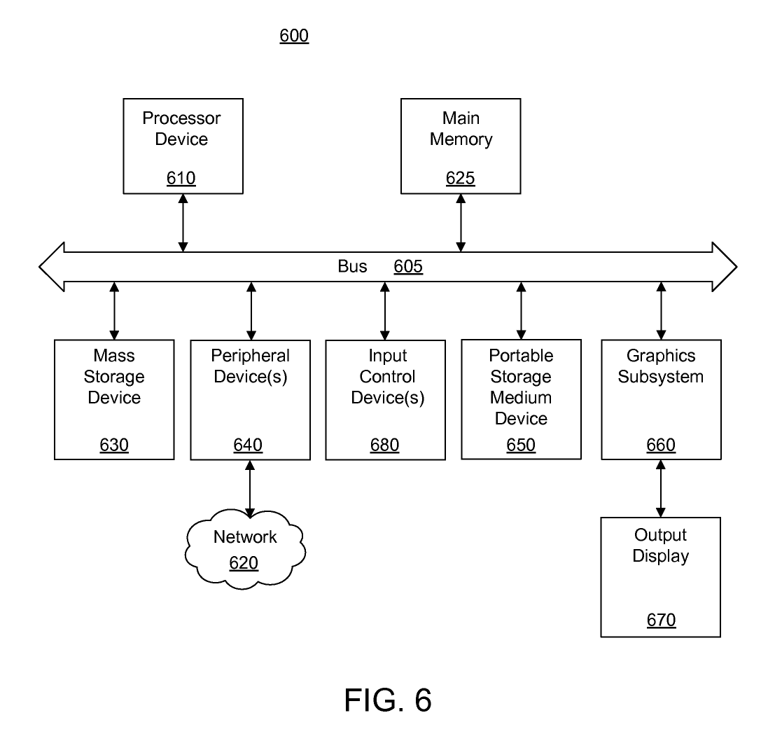

FIG. 6 is a block diagram of a general and/or special purpose computer 600, which may be a general and/or special purpose computing device, that may be employed in accordance with various example embodiments herein. The computer 600 may be, for example, a user device, a user computer, a client computer, and/or a server computer, among other things.

The computer 600 may include without limitation a processor device 610, a main memory 625, and an interconnect bus 605. The processor device 610 may include without limitation a single microprocessor, or may include a plurality of microprocessors for configuring the computer 600 as a multi-processor system. The main memory 625 stores, among other things, instructions and/or data for execution by the processor device 610. The main memory 625 may include banks of dynamic random access memory (DRAM), as well as cache memory.

The computer 600 may further include a mass storage device 630, peripheral device(s) 640, portable non-transitory storage medium device(s) 650, input control device(s) 680, a graphics subsystem 660, and/or an output display 670. For explanatory purposes, all components in the computer 600 are shown in FIG. 6 as being coupled via the bus 605. However, the computer 600 is not so limited. Devices of the computer 600 may be coupled via one or more data transport means. For example, the processor device 610 and/or the main memory 625 may be coupled via a local microprocessor bus. The mass storage device 630, peripheral device(s) 640, portable storage medium device(s) 650, and/or graphics subsystem 660 may be coupled via one or more input/output (I/O) buses. The mass storage device 630 may be a nonvolatile storage device for storing data and/or instructions for use by the processor device 610. The mass storage device 630 may be implemented, for example, with a magnetic disk drive or an optical disk drive. In a software embodiment, the mass storage device 630 is configured for loading contents of the mass storage device 630 into the main memory 625.

The portable storage medium device 650 operates in conjunction with a nonvolatile portable storage medium, such as, for example, a compact disc read only memory (CD-ROM), to input and output data and code to and from the computer 600. In some embodiments, the software for storing information may be stored on a portable storage medium, and may be inputted into the computer 600 via the portable storage medium device 650. The peripheral device(s) 640 may include any type of computer support device, such as, for example, an input/output (I/O) interface configured to add additional functionality to the computer 600. For example, the peripheral device(s) 640 may include a network interface card for interfacing the computer 600 with a network 620.

The input control device(s) 680 provide a portion of the user interface for a user of the computer 600. The input control device(s) 680 may include a keypad and/or a cursor control device. The keypad may be configured for inputting alphanumeric characters and/or other key information. The cursor control device may include, for example, a handheld controller or mouse, a trackball, a stylus, and/or cursor direction keys. In order to display textual and graphical information, the computer 600 may include the graphics subsystem 660 and the output display 670. The output display 670 may include a cathode ray tube (CRT) display and/or a liquid crystal display (LCD). The graphics subsystem 660 receives textual and graphical information, and processes the information for output to the output display 670.

Each component of the computer 600 may represent a broad category of a computer component of a general and/or special purpose computer. Components of the computer 600 are not limited to the specific implementations provided here.

Software embodiments of the example embodiments presented herein may be provided as a computer program product, or software, that may include an article of manufacture on a machine-accessible or machine-readable medium having instructions. The instructions on the non-transitory machine-accessible machine-readable or computer-readable medium may be used to program a computer system or other electronic device. The machine- or computer-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “computer-readable”, “machine-accessible medium” or “machine-readable medium” used herein shall include any medium that is capable of storing, encoding, or transmitting a sequence of instructions for execution by the machine and that causes the machine to perform any one of the methods described herein. Furthermore, it is common in the art to speak of software, in one form or another (e.g., program, procedure, process, application, module, unit, logic, and so on), as taking an action or causing a result. Such expressions are merely a shorthand way of stating that the execution of the software by a processing system causes the processor to perform an action to produce a result.

Portions of the example embodiments of the invention may be conveniently implemented by using a conventional general-purpose computer, a specialized digital computer and/or a microprocessor programmed according to the teachings of the present disclosure, as is apparent to those skilled in the computer art. Appropriate software coding may readily be prepared by skilled programmers based on the teachings of the present disclosure.

Some embodiments may also be implemented by the preparation of application-specific integrated circuits, field programmable gate arrays, or by interconnecting an appropriate network of conventional component circuits.

Some embodiments include a computer program product. The computer program product may be a storage medium or media having instructions stored thereon or therein which can be used to control, or cause, a computer to perform any of the procedures of the example embodiments of the invention. The storage medium may include without limitation a floppy disk, a mini disk, an optical disc, a Blu-Ray Disc, a DVD, a CD or CD-ROM, a micro-drive, a magneto-optical disk, a ROM, a RAM, an EPROM, an EEPROM, a DRAM, a VRAM, a flash memory, a flash card, a magnetic card, an optical card, nanosystems, a molecular memory integrated circuit, a RAID, remote data storage/archive/warehousing, and/or any other type of device suitable for storing instructions and/or data.

Stored on any one of the computer readable medium or media, some implementations include software for controlling both the hardware of the general and/or special computer or microprocessor, and for enabling the computer or microprocessor to interact with a human user or other mechanism utilizing the results of the example embodiments of the invention. Such software may include without limitation device drivers, operating systems, and user applications. Ultimately, such computer readable media further includes software for performing example aspects of the invention, as described above.

Included in the programming and/or software of the general and/or special purpose computer or microprocessor are software modules for implementing the procedures described above.

While various example embodiments of the present invention have been described above, it should be understood that they have been presented by way of example, and not limitation. It will be apparent to persons skilled in the relevant art(s) that various changes in form and detail can be made therein. Thus, the present invention should not be limited by any of the above described example embodiments, but should be defined only in accordance with the following claims and their equivalents.

In addition, it should be understood that the figures are presented for example purposes only. The architecture of the example embodiments presented herein is sufficiently flexible and configurable, such that it may be utilized and navigated in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the example embodiments presented herein in any way. It is also to be understood that the procedures recited in the claims need not be performed in the order presented.

What is claimed is:

1. A system for managing transaction data, the system comprising:
at least one memory operable to store a plurality of record data; and
at least one processor coupled to the at least one memory, the at least one processor being operable to:
receive, over a communications network, first record data from a first reader terminal associated with a first merchant system, the first record data being associated with a first transaction between the first reader terminal and a transaction instrument, the transaction instrument including an application associated with an application identifier (ID);
receive, over a communications network, second record data from a second reader terminal associated with a second merchant system, the second record data being associated with a second contactless transaction between the second reader terminal and the transaction instrument; and
relate the first record data and second record data with a profile corresponding to the application ID,
wherein the first merchant system and the second merchant system are unassociated and not operable to share record data between each other.

2. The system of claim 1, wherein each of the first record data and the second record data include at least one of goods and services transacted for in the first and second transactions, respectively.

3. The system of claim 1, wherein the at least one processor is further operable to transmit the profile to a communicatively coupled apparatus.

4. The system of claim 1, wherein the first and second transactions are contactless transactions and the transaction instrument is a near field communication-enabled instrument.

5. The system of claim 1, wherein the payment device is one of a mobile device or a chip card.

6. The system of claim 5, wherein the application is a mobile wallet application and the application ID is a mobile wallet ID.

7. The system of claim 1, wherein:
the at least one memory is further operable to store user data, the user data being associated with the application ID, and
the at least one processor is further operable to:
receive, over a communications network, the user data associated with the application ID; and
further relate the user data with the profile corresponding to the application ID.

8. A method for reporting contactless transaction data, the method comprising the steps of:
receiving, over a communications network, first record data from a first reader terminal associated with a first merchant system, the first record data being associated with a first transaction between the first reader terminal and a transaction instrument, the transaction instrument including an application associated with an application identifier (ID);
receiving, over a communications network, second record data from a second reader terminal associated with a second merchant system, the second record data being associated with a second contactless transaction between the second reader terminal and the transaction instrument; and
relating the first record data and second record data with a profile corresponding to the application ID,
wherein the first merchant system and the second merchant system are unassociated and not operable to share record data between each other.

9. The method of claim 8, wherein each of the first record data and the second record data include at least one of goods and services transacted for in the first and second transactions, respectively.

10. The method of claim 8, further comprising the step of transmitting the profile to a communicatively coupled apparatus.

11. The method of claim 8, wherein the first and second transactions are contactless transactions and the transaction instrument is a near field communication-enabled instrument.

12. The method of claim 8, wherein the payment device is one of a mobile device or a chip card.

13. The method of claim 12, wherein the application is a mobile wallet application and the application ID is a mobile wallet ID.

14. The method of claim 8, further comprising the steps of:
receiving, over a communications network, user data associated with the application ID; and
further relating the user data with the profile corresponding to the application ID.

15. A non-transitory computer-readable medium having stored thereon sequences of instruction for causing at least one processor to:
receive, over a communications network, first record data from a first reader terminal associated with a first merchant system, the first record data being associated with a first transaction between the first reader terminal and a transaction instrument, the transaction instrument including an application associated with an application identifier (ID);
receive, over a communications network, second record data from a second reader terminal associated with a second merchant system, the second record data being associated with a second contactless transaction between the second reader terminal and the transaction instrument; and
relate the first record data and second record data with a profile corresponding to the application ID,
wherein the first merchant system and the second merchant system are unassociated and not operable to share record data between each other.

16. The non-transitory computer-readable medium of claim 15, wherein each of the first record data and the second record data include at least one of goods and services transacted for in the first and second transactions, respectively.

17. The non-transitory computer-readable medium of claim 15, having stored thereon further sequences of instruction for causing at least one processor to transmit the profile to a communicatively coupled apparatus.

18. The non-transitory computer-readable medium of claim 15, wherein the first and second transactions are contactless transactions and the transaction instrument is a near field communication-enabled instrument.

19. The non-transitory computer-readable medium of claim 15, wherein the payment device is one of a mobile device or a chip card.

20. The non-transitory computer-readable medium of claim 19, wherein the application is a mobile wallet application and the application ID is a mobile wallet ID.

21. The non-transitory computer-readable medium of claim 15, having stored thereon further sequences of instruction for causing at least one processor to:
receive, over a communications network, the user data associated with the application ID; and
further relate the user data with the profile corresponding to the application ID.
